(19) United States
(12) Patent Application Publication
(10) Pub. No.: US 2025/0023860 A1
(43) Pub. Date: Jan. 16, 2025

(54) ENTERPRISE-MANAGED AUTHENTICATION AND AUTHORIZATION

(71) Applicant: Cisco Technology, Inc., San Jose, CA (US)

(72) Inventors: Vincent E. Parla, North Hampton, NH (US); Michael F. O'Gorman, Redwood City, CA (US); Cullen Frishman Jennings, Calgary (CA)

(21) Appl. No.: 18/219,901

(22) Filed: Jul. 10, 2023

(51) Int. Cl. H04L 9/40

(52) U.S. Cl. CPC H04L 63/0815; H04L 63/083

(57) ABSTRACT

Techniques for syncing authentication and/or authorization tokens, cookies, and related metadata across different browser instances to enable disparate applications to share a single authentication/authorization ceremony. The techniques may include receiving a policy indicating multiple enterprise-managed applications that are capable of sharing tokens or cookies for user authentication. The techniques may also include receiving a token or a cookie indicating that a user is authenticated to access a first application of the multiple enterprise-managed applications. Based at least in part on the policy, the token or the cookie may be provided to a browser such that a second application of the multiple enterprise-managed applications refrains from causing the user to authenticate for access to the second application.

### TECHNICAL FIELD

The present disclosure relates generally to techniques for, among other things, syncing authentication and/or authorization tokens, cookies, and related metadata across different browser instances to enable disparate applications to share a single authentication/authorization ceremony.

### BACKGROUND

Single sign-on (SSO) has become one of the most popular authentication and authorization technologies available. However, one of the problems with SSO is that many non-browser applications, including virtual private network (VPN) clients, email clients, etc., leverage an embedded browser to perform SSO authentication ceremonies. This results in the limitation that one authentication ceremony in an application cannot be shared with another application that uses its own embedded browser instance.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture in which various aspects of the techniques disclosed herein may be performed to sync authentication and/or authorization tokens or cookies across different browser instances to enable disparate applications to share a single authentication/authorization ceremony.

FIG. 2 is a pictorial flow diagram illustrating an example method associated with the techniques described herein for policy-based sharing of SSO tokens/cookies between applications.

FIG. 3 is a pictorial flow diagram illustrating an example method associated with the techniques described herein for policy-based sharing of SSO tokens/cookies between applications on different user devices.

FIG. 4 is a flow diagram illustrating an example method associated with the techniques described herein.

FIG. 5 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This application is directed to techniques for syncing authentication and/or authorization tokens and/or cookies across different browser instances to enable disparate applications to share a single authentication/authorization ceremony. By way of example, and not limitation, a method according to the techniques disclosed herein may include receiving a policy indicating multiple enterprise-managed applications that are capable of sharing tokens or cookies for user authentication. The method may also include receiving a token or a cookie indicating that a user is authenticated to access a first application of the multiple enterprise-managed applications. Based at least in part on the policy, the token or the cookie may be provided to a browser such that a second application of the multiple enterprise-managed applications refrains from causing the user to authenticate for access to the second application.

Additionally, the techniques described herein may be performed as a method and/or by a system having non-transitory computer-readable media storing computer-executable instructions that, when executed by one or more processors, performs the techniques described above and herein.

### Example Embodiments

As noted above, non-browser applications, including virtual private network (VPN) clients, email clients, etc., leverage an embedded browser to perform single sign-on SSO authentication ceremonies. This results in the limitation that one authentication ceremony in an application cannot be shared with another application that uses its own embedded browser instance.

This application is directed to techniques for syncing an authentication token or cookie across different browser instances to enable disparate applications to share a single authentication/authorization ceremony. For example, using application management tools, including mobile device management (MDM) ecosystems, enterprise mobility management (EMM) ecosystems, etc., enterprise administrators may manage and/or provision multiple applications (e.g., non-browser or browser-based applications) for enterprise users (e.g., employees, clients, etc.). In doing so, the enterprise administrators may set policies allowing certain applications to share a common token/cookie store for SSO access. Such a policy may allow the embedded browser(s) used inside these application(s) to share cookies/tokens (e.g., bearer tokens, jots, HTTP cookies, java web tokens (JWTs), etc.) across processes. That is, instead of the cookies/tokens being constrained in a single application/browser process that it was launched from, these new policies may allow the cookies/tokens to be expanded for use by some or all of the enterprise-managed applications running on a user's device(s). In this way, when an enterprise user accesses an enterprise-managed application and authenticates for access (e.g., via a multi-factor authentication (MFA) prompt/challenge, entering credentials, etc.), the user—and more specifically, the browser instance—would receive an SSO cookie/token in return. Based on the enterprise-defined policy, this SSO cookie/token may then be installed into the enterprise cookie/token store (e.g., which may exist in the cloud an/or be stored locally on the user's device and synced with the user's other devices) and the other enterprise-managed applications that have permission can access that cookie/token so it does not have to do another authentication again in its own embedded browser.

By way of example, and not limitation, a method according to the techniques disclosed herein may include receiving a policy indicating multiple enterprise-managed applications that are capable of (or restricted from) sharing tokens or cookies for user authentication. In examples, this policy may provide a way for an enterprise cookie/token store to exist at the operating system (OS) level of a user's device(s) to store authentication cookies/token commonly for the set of applications—defined in the policy—that are allowed to share one or more cookies/tokens.

In some examples, the policy may indicate which specific applications of the enterprise-managed applications are allowed to share SSO tokens/cookies and which applications are not allowed. In some examples, the applications that are allowed or not allowed to share SSO tokens/cookies may vary under certain circumstances. For instance, the applications that are allowed or not allowed to share SSO tokens/cookies may be varied from user to user based on a user's entitlements, a user's security grouping, and/or the like. Additionally, or alternatively, the applications that are allowed or not allowed to share SSO tokens/cookies may be varied based on a security posture of a user's device, which may be based on whether the device is an enterprise-managed device, whether the device is a known/trusted device, a security level of the network(s) utilized by the device to connect (e.g., public network versus private network), etc. In some examples, the applications allowed or not allowed to share SSO tokens/cookies may vary based on the type of application (e.g., email-related, productivity-related, sales-related, etc.).

In some examples, MDM or GPO policies may be utilized to manage application entitlements regarding which applications can share cookies/tokens via their embedded browser instances, as well as which specific tokens/cookies, and other metadata, can be shared. In some examples, a webservice may be utilized to share/sync an individual cookie/token and/or the enterprise cookie/token store across devices. In some examples, the cookie/token sharing functionality disclosed herein may require or otherwise be enabled by a proof of possession step to prevent cookie/token harvesting from one device and using thar cookie/token on another device. For instance, this proof of possession step may be performed using any number of standard, cryptographic techniques where proof of possession of a private cryptographic key is performed, including, but not limited to, cryptographic signing and/or encryption methodologies.

In some examples, the method may include receiving a token, cookie, and/or other metadata indicating that a user of a client device is authenticated to access a first application of the multiple enterprise-managed applications. That is, the received token/cookie may be an authentication token/cookie and/or session token/cookie that is to be included in subsequent requests from the client device during interaction with the application. In examples, the token or the cookie may be a JWT, an HTTP cookie, an SSO cookie, a session cookie, and/or the like. In some examples, the token/cookie may be initially received at the application or its embedded browser and from a server associated with the application, and then subsequently provided to and received by the enterprise cookie/token store, which may be stored locally on the client device and/or remotely in the cloud.

In some examples, standard DLL, module injection, or function hooking techniques may be used to make the enterprise cookie/token store available/visible inside of the policy-approved embedded browser instances. For instance, any number of API hooking techniques may be used to intercept the normal cookie/token functions of the OS or browser. In some examples, applications and/or their embedded browsers may be configured to automatically store SSO cookies/tokens in the enterprise cookie/token store when they are received. Additionally, or alternatively, the enterprise cookie/token store may monitor whether SSO cookies/tokens are received/stored by an application/browser and then retrieve them automatically from those applications enabled by the policy. In some examples, the enterprise cookie/token store may exist at an OS level of the client device(s) to enable this behavior.

In some examples, based at least in part on the policy, the method may include providing the token or the cookie to a browser associated with a second application of the multiple enterprise-managed applications such that the second application refrains from causing the user to authenticate for access to the second application. For instance, the policy may indicate that the second application is one of the applications allowed to use the shared cookies/tokens. In some examples, the browser may be an embedded browser in the second application or a browser utilized to access the second application.

In some examples, the enterprise cookie/token store may be shared across both native and embedded browser instances based on the policy. Additionally, in some examples, the policy may limit access for the native browser based on domains instead of applications, and/or application limits may also include domains (e.g., cookie X is only available to Outlook for a.b.com domain). A few possible ways exist to implement this functionality. For instance, a browser or OS vendor may extend a webkit framework to support this feature natively in the embedded browser instances. Additionally, or alternatively, an enterprise application programming interface (API) extension may be used and supported by most browsers and OS webkits.

In some examples, the enterprise cookie/token store disclosed herein may be capable of supporting a partitioning concept where access is granted to certain applications to store and share cookies/tokens in a given partition (e.g., similar to OS file partitioning and setting access permissions by application, instead of by user). For instance, each application may have read, write, or both access permissions to a given partition. Additionally, in some examples, individual partitions may be synced across devices similarly to the described mechanism for sharing the entire cookie/token store. In other words, a device may only be allowed to sync a set of partitions with other devices, based on policy, versus the entire cookie/token store. For instance, the user may authenticate to access the first application from a first device, and then the token/cookie may be provided/synced to a second device based on policy. In this way, the user may seamlessly utilize the second device to access the first application (or other applications specified in the policy) without having to reauthenticate with the first application itself. That is, when the user utilizes the second device to access the first application or another application, the cookie/token may be used to prove authentication/authorization and cause the application to refrain from causing the user to be reauthenticated.

In multi-tab instances (e.g., like the external browser itself), an additional policy option may allow constraint of the shared cookie/token store access to the domain/URL in a tab instance, which typically runs in an external browser process. Additional policies may include limiting the sharing of cookies/tokens by key/value or name indicators. On desktop platforms, standard DLL injection techniques or other hooking techniques may be used to chain together the normal cookie/token storage and the enterprise cookie/token store to make them appear as a single cookie/token store for processes that are allowed to share by the policy.

As noted above, in addition—or alternatively—to receiving/sharing authentication/authorization cookies/tokens, metadata may be received/shared for implementing the functionality of the techniques disclosed herein. In some examples, this metadata may include common enterprise configurations, such as a MASQUE relay or a proxy to use for proxying these application connections. In another example, the metadata may include application-specific metadata that may carry some identity attribution (e.g., a UPN, for example) associated with that organization that is shared amongst the collection of applications.

According to the technologies disclosed herein, several advantages in computer-related technology may be realized. For instance, an enterprise cookie/token store running at the OS level of a user device allows for enterprise users to seamlessly access different applications without having to reauthenticate if the enterprise user changes device or opens a new application. Because the cookie/token sharing is policy driven, enterprises are able to securely manage which applications, users, and/or devices are allowed to participate in this functionality. Additionally, because the techniques disclosed herein are configured to work for enterprise-managed applications (e.g., which are generally thick applications running embedded browsers) the techniques may refrain from sharing confidential/private information with the full browser or OS browser on a user's device. As such, the techniques disclosed do not violate any Zero Trust principles and are features that an IT administrator can opt-in to for their enterprise-managed applications to provide an enhanced and more productive user experience. Other advantages in computer-related technology will be readily apparent to those having ordinary skill in the art.

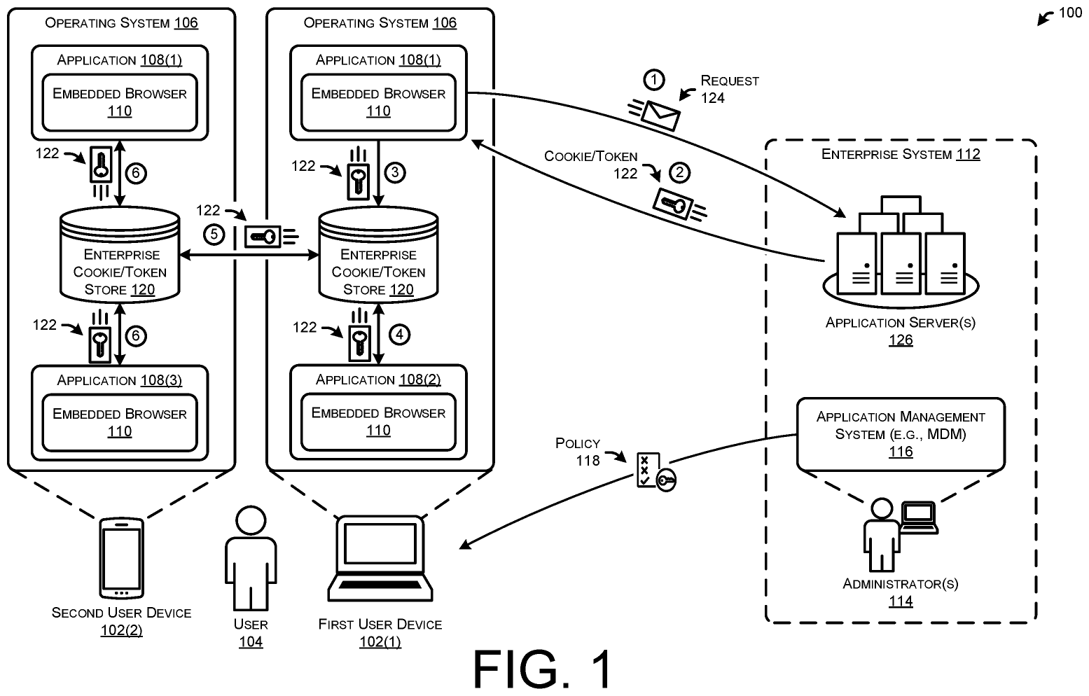

FIG. 1 illustrates an example architecture 100 in which various aspects of the techniques disclosed herein may be performed to sync authentication tokens or cookies across different browser instances to enable disparate applications to share a single authentication/authorization ceremony. The architecture 100 includes a first user device 102(1) (e.g., computer) and a second user device 102(2) (e.g., smartphone), which are associated with a same user 104. Each of the first user device 102(1) and the second user device 102(2) may include a respective operating system 106, which is utilized to run various applications 108. For instance, the first user device 102(1) may utilize its operating system 106 to run a first application 108(1) and a second application 108(2), while the second user device 102(2) may utilize its operating system 106 to run the first application 108(1) and a third application 108(3). In examples, each of the applications 108 may include a respective instance of an embedded browser 110.

The architecture 100 also includes an enterprise system 112. Within the enterprise system 112 (e.g., either logically or physically), administrator(s) 114 (e.g., IT administrator(s)) may utilize an application management system 116 (e.g., MDM systems and others) to manage and/or provision the applications 108 on the user devices that are part of, or managed by, the enterprise system 112. The administrator(s) 114 may also utilize the application management system 116 to set and push policy 118 to the user devices. The policy 118 may define which applications and/or which devices can share cookies/tokens, and, in some instances, under what conditions. For instance, with reference to FIG. 1, the policy 118 may indicate that the application 108(1) on the first user device 102(1) is capable of sharing cookies/tokens with the application 108(2) on the first user device 102(1), as well as sharing cookies/tokens with the applications 108(1) and 108(3) on the second user device 102(2). In some examples, the policy 118 may provide a way for an enterprise cookie/token store 120 to exist at the operating system 106 level of the first user device 102(1) and the second user device 102(2) to store authentication cookies/tokens, such as the cookie/token 122, commonly for the set of applications—defined in the policy 118—that are allowed to share one or more of the cookies/tokens. In some examples, the applications 108 that are allowed or not allowed to share SSO tokens/cookies may vary under certain circumstances. For instance, the applications 108 that are allowed or not allowed to share SSO tokens/cookies may be varied from user to user based on a user's entitlements, a user's security grouping, and/or the like. Additionally, or alternatively, the applications 108 that are allowed or not allowed to share SSO tokens/cookies may be varied based on a security posture of a user's device, which may be based on whether the device is an enterprise-managed device, whether the device is a known/trusted device, a security level of the network(s) utilized by the device to connect (e.g., public network versus private network), etc. In some examples, the applications 108 allowed or not allowed to share SSO tokens/cookies may vary based on the type of application (e.g., email-related, productivity-related, sales-related, etc.).

An example workflow is shown in FIG. 1 to help illustrate how cookies/tokens may be shared, based on the policy 118, according to the techniques disclosed herein. At “1”, the application 108(1) and/or the embedded browser sends a request 124 to backend application server(s) 126. In some examples, the application server(s) 126 may be located in a datacenter associated with the enterprise system 112, belong to a cloud-service provider, or the like. In some examples, the request 124 may be a request for authentication/authorization of the user 104 of the first user device 102(1) to access application 108(1) resources. For instance, if the application 108(1) is Office 365, the request 124 may be to authenticate/authorize the user 104 and/or the first user device 102(1) to access a document, spreadsheet, files, etc.

At “2,” based at least in part on the user 104 of the first user device 102(1) successfully authenticating and/or being authorized, the application server(s) 126 may send the cookie/token 122 (e.g., session cookie/token, authentication cookie/token, SSO cookie/token, JWT, etc.) to the first user device 102(1) and/or the embedded browser 110 of the application 108(1) for use to access the application resources. That is, the application 108(1)/embedded browser 110 may include the cookie/token 122 in subsequent transactions with the application server(s) 126 to indicate that the device/user is authenticated and to keep the session open.

At “3,” the application 108(1) and/or embedded browser 110 may provide the cookie/token 122 to the enterprise cookie/token store 120. In some examples, the enterprise cookie/token store 120 may evaluate the policy 118 and—if the policy allows—the enterprise cookie/token store 120 may, at “4,” make the cookie/token 122 available to other, approved applications running on the first user device 102(1). Additionally, at “5,” the enterprise cookie/token store 120 on the first user device 102(1) may make sync the cookie/token 122 with another instance of the enterprise cookie/token store 120 on the second user device 102(2). The second instance of the enterprise cookie/token store 120 may then, at “6,” evaluate the policy 118 and make the cookie/token 122 available to other approved applications on the second user device 102(2).

In some examples, standard DLL, module injection, or function hooking techniques may be used to make the enterprise cookie/token store 120, and/or the cookies/tokens stored therein, available/visible inside of the policy-approved embedded browser 110 instances. For instance, any number of API hooking techniques may be used to intercept the normal cookie/token functions of the operating system 106 and/or the embedded browser 110. In some examples, the enterprise cookie/token store 120 may be shared across both native and embedded browser instances based on the policy 118. Additionally, in some examples, the policy 118 may limit access for the native browser based on domains instead of applications, and/or application limits may also include domains (e.g., cookie X is only available to Outlook for a.b.com domain).

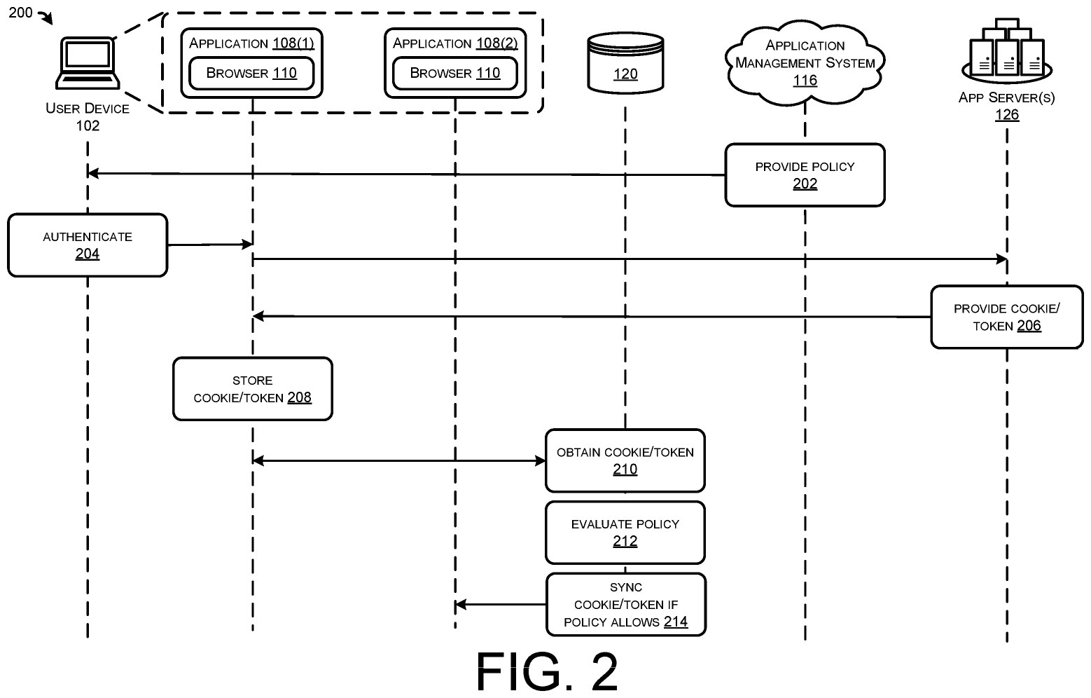

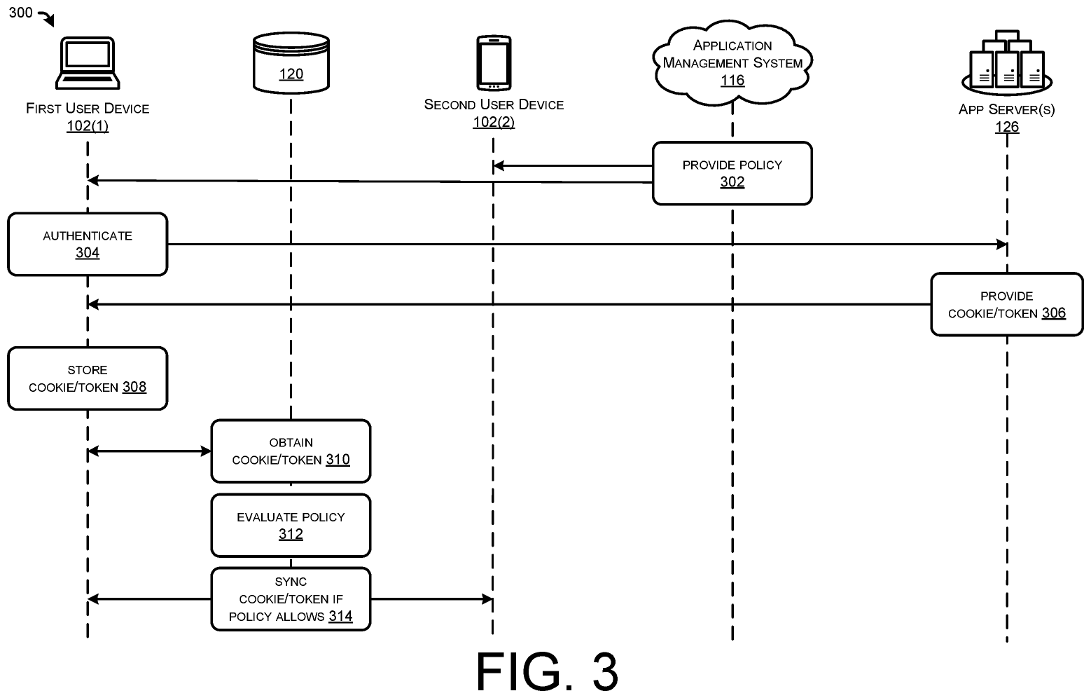

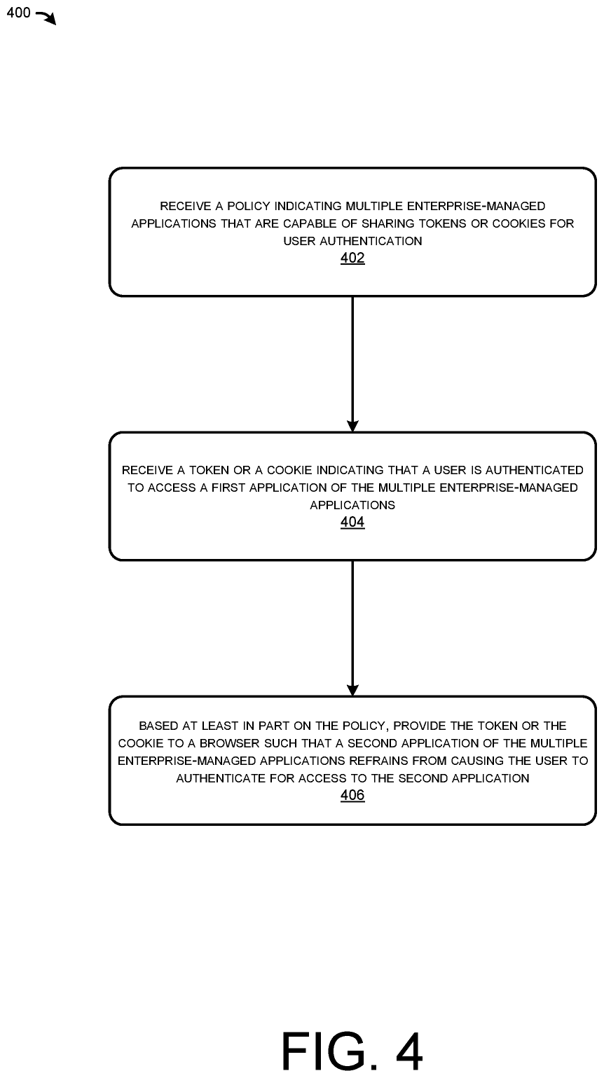

FIGS. 2 and 3 are pictorial flow diagrams illustrating example methods 200 and 300 associated with the techniques described herein. FIG. 4 is a flow diagram illustrating an example method 400 associated with the techniques described herein. The logical operations described herein with respect to FIGS. 2-4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 2-4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 2 is a pictorial flow diagram illustrating an example method 200 associated with the techniques described herein for policy-based sharing of SSO tokens/cookies between applications. At operation 202, the application management system 116 may provide a policy to the user device 102. That is, in some examples, an enterprise IT admin may provision the policy to enterprise devices using the application management system 116. The policy may specify which applications are allowed to share a single cookie/token for user authentication/authorization purposes. For instance, the policy may indicate that the applications 108(1) and 108(2) running on the user device 102 are allowed to share SSO cookies/tokens.

At operation 204, the user device 102 may authenticate with the application server(s) 126 to access resources provided by the application 108(1). In examples, the embedded browser 110 may be utilized to authenticate the user/user device 102 to access the application 108(1).

At operation 206, the application server(s) 126 may provide the cookie/token to the application 108(1) (e.g., to the embedded browser 110). The cookie/token may be included with subsequent requests to the application to prove authentication/authorization, to track the user's session, etc. As such, the embedded browser 110 and/or the application 108(1), at operation 208, may store the cookie/token for use.

At operation 210, the enterprise cookie/token store 120 may obtain the cookie/token from the application 108(1) and/or the embedded browser 110 of the application 108(1). In some examples, the application 108(1) may be configured to store the cookie/token in the enterprise cookie/token store 120. Additionally, or alternatively, the enterprise cookie/token store 120 may periodically poll the application 108(1) and/or the embedded browser 110 to fetch the cookies/tokens. For instance, instead of the application 108(1) or its embedded browser 110 storing its cookies/tokens locally in its own processes (which is the traditional case), the cookies/tokens may be stored in the enterprise cookie/token store 120. In this way, the application 108(1) may access the enterprise cookie/token store 120 when it sends requests to the application server(s) 126 and obtain any relevant cookies/tokens that are necessary to include in the requests/transactions.

At operation 212, the enterprise cookie/token store 120 may evaluate the policy of the user device 102 that was received from the application management system 116. If the policy allows, as it does in FIG. 2, the enterprise cookie/token store 120 may, at operation 214, sync the cookie/tokens with the second application 108(2) and/or its embedded browser 110. In this way, when the user attempts to access the application server(s) 126 associated with the second application 108(2), the user does not have to authenticate again or otherwise work through another SSO workflow/authentication ceremony.

FIG. 3 is a pictorial flow diagram illustrating an example method 300 associated with the techniques described herein for policy-based sharing of SSO tokens/cookies between applications on different user devices. At operation 302, the application management system 116 may provide a policy to the first user device 102(1) and the second user device 102(2). That is, in some examples, an enterprise IT admin may provision the policy to enterprise devices using the application management system 116. The policy may specify which applications are allowed to share a single cookie/token for user authentication/authorization purposes. For instance, the policy may indicate that the first user device 102(1) and the second user device 102(2) are allowed to share SSO cookies/tokens for certain enterprise-managed applications.

At operation 304, the first user device 102(1) may authenticate with the application server(s) 126 to access application resources. In examples, the application the first user device 102(1) is accessing may be a non-browser-based application that, instead, utilizes an embedded browser to access application resources, as well as to authenticate the user of the first user device 102(1) to access the application.

At operation 306, the application server(s) 126 may provide the cookie/token to the first user device 102(1). The cookie/token may be included with subsequent requests to the application to prove authentication/authorization, to track the user's session, etc. As such, the first user device, at operation 308, may store the cookie/token for use. That is, in some examples, the non-browser-based application running on the first user device 102(1) and/or its embedded browser may store the cookie/token.

At operation 310, the enterprise cookie/token store 120 may obtain the cookie/token from the first user device 102(1) (e.g., from the non-browser-based application running on the first user device 102(1) and/or its embedded browser). In some examples, the first user device 102(1) may be configured to store the cookie/token in the enterprise cookie/token store 120. Additionally, or alternatively, the enterprise cookie/token store 120 may periodically poll the first user device 102(1) to fetch the cookies/tokens. For instance, instead of the non-browser-based application or its embedded browser storing its session/auth cookies/tokens locally in its own processes (which is the traditional case), the cookies/tokens may be stored in the enterprise cookie/token store 120. In this way, the various applications running on the first user device 102(1) may access the enterprise cookie/token store 120 when they send requests to the application server(s) 126 and obtain any relevant cookies/tokens that are necessary to include in the requests/transactions.

At operation 312, the enterprise cookie/token store 120 may evaluate the policy that was received from the application management system 116. If the policy allows, as it does in FIG. 3, the enterprise cookie/token store 120 may, at operation 314, sync the cookie/token with the second user device 102(2). In this way, when the user attempts to access the application server(s) 126 using the second user device 102(2), the user does not have to authenticate again or otherwise work through another SSO workflow/authentication ceremony. For instance, the policy may specify that the cookies/tokens may be shared between the first user device 102(1) and the second user device 102(2) if the second user device 102(2) was used to complete an MFA workflow for the first user device 102(1) to access the application, or vice-versa. Thus, if it is determined that the second user device 102(2) was in fact used to complete the MFA workflow, the enterprise cookie/token store 120 may be synced-along with its cookies/tokens stored therein-between the first user device 102(1) and the second user device 102(2).

FIG. 4 is a flow diagram illustrating an example method 400 associated with the techniques described herein. The method 400 begins at operation 402, which includes receiving a policy indicating multiple enterprise-managed applications that are capable of sharing tokens or cookies for user authentication. For instance, the first user device 102(1) and/or the second user device 102(2) may receive the policy 118 indicating multiple enterprise-managed applications that are capable of sharing tokens or cookies for user authentication.

At operation 404, the method 400 includes receiving a token or a cookie indicating that a user is authenticated to access a first application of the multiple enterprise-managed applications. For instance, the enterprise cookie/token store 120 may receive the token/cookie 122 indicating that the user 104 is authenticated to access the first application 108(1) of the multiple enterprise-managed applications.

At operation 406, the method 400 includes, based at least in part on the policy, providing the token or the cookie to a browser such that a second application of the multiple enterprise-managed applications refrains from causing the user to authenticate for access to the second application. For instance, the enterprise cookie/token store 120 may provide the token/cookie 122 to the embedded browser(s) 110 of the other applications 108(1)-108(3) such that the other applications 108(1)-108(3) refrain from causing the user 104 to authenticate for access to the other applications 108(1)-108(3).

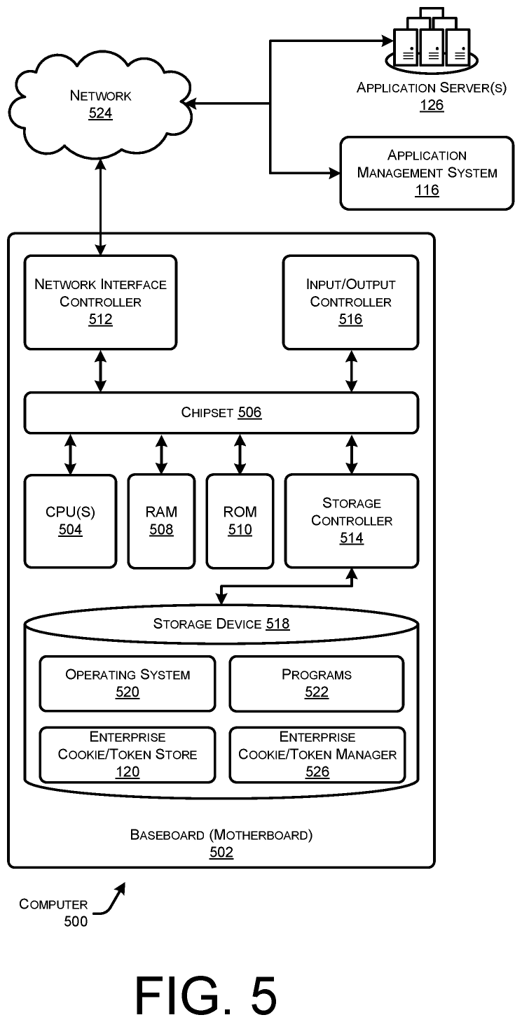

FIG. 5 is a computer architecture diagram showing an illustrative computer hardware architecture for implementing a computing device that can be utilized to implement aspects of the various technologies presented herein. The computer architecture shown in FIG. 5 may be illustrative of a conventional server computer, router, switch, workstation, desktop computer, laptop (e.g., first user device 102(1)), tablet, network appliance, e-reader, smartphone (e.g., second user device 102(2)), load balancer, or other computing device, and can be utilized to execute any of the software components presented herein.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network. The chipset 506 can include functionality for providing network connectivity through a NIC 512, such as a gigabit Ethernet adapter. The NIC 512 is capable of connecting the computer 500 to other computing devices over the network 524, such as the application management system 116 and/or the application server(s) 126. It should be appreciated that multiple NICs 512 can be present in the computer 500, connecting the computer to other types of networks and remote computer systems. In some examples, the NIC 512 may be configured to perform at least some of the techniques described herein.

The computer 500 can be connected to a storage device 518 that provides non-volatile storage for the computer. The storage device 518 can store an operating system 520 (e.g., which may be similar to the operating system 106), programs 522 (e.g., applications 108), and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the architecture 100 and/or any components included therein, may be supported by one or more devices similar to computer 500. Stated otherwise, some or all of the operations performed by the architecture 100 and/or any components included therein, may be performed by one or more computer devices 500 operating in a scalable arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes and functionality described above with regard to FIGS. 1-4, and herein. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in FIG. 5, can include other components that are not explicitly shown in FIG. 5, or might utilize an architecture completely different than that shown in FIG. 5.

The computer 500 may include one or more hardware processors (processors) configured to execute one or more stored instructions. The processor(s) may comprise one or more cores. Further, the computer 500 may include one or more network interfaces configured to provide communications between the computer 500 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure for syncing an authentication token or cookie across different browser instances to enable disparate applications to share a single authentication/authorization ceremony.

The storage device 518 may also include the enterprise cookie/token store 120 described herein, as well as an enterprise cookie/token manager 526. In some examples, the enterprise cookie/token manager 526 may make decisions, based on policy, as to which cookies/tokens in the enterprise cookie/token store 120 are to be shared with other devices and/or other application processes.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving a policy indicating multiple enterprise-managed applications that are capable of sharing tokens or cookies for user authentication;
receiving a token or a cookie indicating that a user is authenticated to access a first application of the multiple enterprise-managed applications; and
based at least in part on the policy, providing the token or the cookie to a browser associated with a second application of the multiple enterprise-managed applications such that the second application refrains from causing the user to authenticate for access to the second application.

2. The method of claim 1, wherein the browser is an embedded browser associated with the second application, the embedded browser utilized to authenticate the user for access to the second application.

3. The method of claim 1, wherein the policy further indicates that the token or the cookie is capable of being shared across different devices associated the user.

4. The method of claim 3, wherein:
the user authenticated to access the first application from a first device,
the token or the cookie is provided to the browser on a second device, and
based on the policy and the token or the cookie, the second application refrains from causing the user to authenticate for access to the second application on the second device.

5. The method of claim 1, further comprising determining that the token or the cookie was stored by the browser in association with the user authenticating to access the first application, wherein receiving the token or the cookie comprises obtaining, based at least in part on the policy, the token or the cookie stored by the browser.

6. The method of claim 1, further comprising storing the token or the cookie in a location at an operating system level of a device utilized by the user to access the first application or the second application.

7. The method of claim 1, wherein the policy further indicates an enterprise-managed application that is restricted from sharing tokens or cookies for user authentication.

8. The method of claim 7, further comprising refraining from sharing the token or the cookie with an embedded browser associated with the enterprise managed application based at least in part on the policy.

9. The method of claim 7, further comprising:
receiving a second token or a second cookie indicating that the user is authenticated to access the enterprise-managed application; and
based at least in part on the policy, refraining from sharing the second token or the second cookie.

10. A system comprising:
one or more processors; and
one or more non-transitory computer-readable media storing instructions that, when executed, cause the one or more processors to perform operations comprising:
receiving a policy indicating multiple enterprise-managed applications that are capable of sharing tokens or cookies for user authentication;
receiving a token or a cookie indicating that a user is authenticated to access a first application of the multiple enterprise-managed applications; and
based at least in part on the policy, providing the token or the cookie to a browser associated with a second application of the multiple enterprise-managed applications such that the second application refrains from causing the user to authenticate for access to the second application.

11. The system of claim 10, wherein the browser is an embedded browser associated with the second application, the embedded browser utilized to authenticate the user for access to the second application.

12. The system of claim 10, wherein the policy further indicates that the token or the cookie is capable of being shared across different devices associated the user.

13. The system of claim 12, wherein:
the user authenticated to access the first application from a first device,
the token or the cookie is provided to the browser on a second device, and
based on the policy and the token or the cookie, the second application refrains from causing the user to authenticate for access to the second application on the second device.

14. The system of claim 10, the operations further comprising determining that the token or the cookie was stored by the browser in association with the user authenticating to access the first application, wherein receiving the token or the cookie comprises obtaining, based at least in part on the policy, the token or the cookie stored by the browser.

15. The system of claim 10, the operations further comprising storing the token or the cookie in a location at an operating system level associated with a device utilized by the user to access the first application or the second application.

16. The system of claim 10, wherein the policy further indicates an enterprise-managed application that is restricted from sharing tokens or cookies for user authentication.

17. The system of claim 16, the operations further comprising:
refraining from sharing the token or the cookie with an embedded browser associated with the enterprise managed application based at least in part on the policy;
receiving a second token or a second cookie indicating that the user is authenticated to access the enterprise-managed application; and
based at least in part on the policy, refraining from sharing the second token or the second cookie.

18. One or more non-transitory computer-readable media storing instructions that, when executed, cause one or more processors to perform operations comprising:
receiving a policy indicating multiple enterprise-managed applications that are capable of sharing tokens or cookies for user authentication;
receiving a token or a cookie indicating that a user is authenticated to access a first application of the multiple enterprise-managed applications; and
based at least in part on the policy, providing the token or the cookie to a browser associated with a second application of the multiple enterprise-managed applications such that the second application refrains from causing the user to authenticate for access to the second application.

19. The one or more non-transitory computer-readable media of claim 18, wherein the browser is an embedded browser associated with the second application, the embedded browser utilized to authenticate the user for access to the second application.

20. The one or more non-transitory computer-readable media of claim 18, wherein:
the policy further indicates that the token or the cookie is capable of being shared across different devices associated the user,
the user authenticated to access the first application from a first device, and
the second application refrains from causing the user to authenticate for access to the second application from a second device.
